(19) United States
(12) Patent Application Publication
(10) Pub. No.: US 2004/0059065 A1
(43) Pub. Date: Mar. 25, 2004

(54) Crosslinked anion-exchange resin or salt thereof

(76) Inventors: Takeshi Goto, Tskuba-shi (JP); Kazuhisa Yoshitake, Tsukuba-shi (JP); Kazuteru Moriyama, Tsukuba-shi (JP); Shuichi Toriya, Suita-shi (JP); Tsutomu Yuasa, Osaka-shi (JP); Hideyuki Nishibayashi, Kobe-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/221,020

(22) PCT Filed: Mar. 9, 2001
(86) PCT No.: PCT/JP01/01851

(30) Foreign Application Priority Data
Mar. 9, 2000 (JP) 2000-65493

(51) Int. Cl. C08F 8/00

(52) U.S. Cl. 525/326.1; 525/383

(57) ABSTRACT

A crosslinked anion exchange resin or a salt thereof obtained by reacting a polymer (A) having amino and/or imino groups in the total number of two or more per molecule with a compound (B) having a vinyl group capable of reacting in Michael addition reaction and a carboxylic ester group, and thus by making the amino and/or imino groups contained in the polymer (A) add to the vinyl group in the compound (B) and form a amide-bond with the carboxylic ester group in the compound (B).

### TECHNICAL FIELD

The present invention relates to a crosslinked anion exchange resin or a salt thereof that is crosslinked by a compound having a vinyl group capable of reacting in the Michael addition reaction and a carboxylic ester group. This crosslinked anion exchange resin has a high adsorption capacity with respect to phosphorus compounds such as phosphate, and thus can be used as a phosphorus adsorbent for use in purification of water in lakes, lagoons, rivers or the like, or as a preventive and/or therapeutic agent of hyperphosphatemia for use in medical treatment.

### BACKGROUND ART

It is known that a patient with renal dysfunction gradually loses a capability to excrete the body's phosphorus into urine due to a decline in renal functions associated with deterioration of the renal lesion, and results in hyperphosphatemia. In patients who suffer from the condition of hyperphosphatemia for an extended period, phosphorus accumulated in the body induces various hazards such as a decrease in serum calcium, and thus medical treatment of hyperphosphatemia was indispensable for the patients.

For the treatment of hyperphosphatemia, a therapy by oral administration of a phosphorus adsorbent has been practiced as well as the dietetic therapy. The therapy by oral administration of a phosphorus adsorbent is based on a function of the phosphorus adsorbent to adsorb and trap phosphate ions present in food the patient ingested, thus suppressing intake and accumulation of phosphorus in the body and consequently reducing phosphorus concentration in blood. Currently, three kinds of medicines, aluminum preparations, calcium preparations and magnesium preparations, are mainly used as the oral phosphorus adsorbents. But since the medicines are necessarily administrated for a prolonged term for those patients with renal failure, the aluminum preparations containing aluminum hydroxide raise a problem of adverse reactions such as aluminum encephalopathy and aluminum osteopathy induced by the uptake of aluminum into the patient body. Additionally, the calcium preparations (calcium carbonate, calcium acetate) have the problem since they have lower phosphorus adsorption capacities compared to the aluminum preparations, demanding an increased administration of the medicine and consequently resulting in an uptake of more calcium possibly leading to hypercalcemia. Moreover, the magnesium preparations (magnesium carbonate) have a problem of hypermagnesemia, as with the calcium preparations.

In view of the problems associated with the conventional oral phosphorus adsorbents for medicine, recently, methods to use an anion exchange resin as the phosphorus adsorbent have been studied. For example, Japanese PCT International Publication No. 9-504782 (WO95/05184) discloses that an anion exchange resin of polyallylamine hydrochloride crosslinked with epichlorohydrin can be used as a medicinal phosphoric acid adsorbent. Additionally, in Japanese Unexamined Patent Publication No. 9-295941 is disclosed that 2-methylimidazole-epichlorohydrin copolymer, cholestyramine and the like that were used as bile acid adsorbents can also be used as medicinal phosphorus adsorbents, and in Japanese PCT International Publication No. 8-506846 (WO96/25440) is disclosed that an anion exchange resin having guanitidyl (sic) groups adsorbs phosphoric acid.

Although most of these anion exchange resins exhibited sufficient adsorption capacities with respect to phosphate ion, there were some resins that should be administered in a greater amount to raise the therapeutic effect. According to a survey in the U.S., about 25% of the renal failure patients were concurrently suffering from hyperlipemia, while the remaining 75% patients were not required to decrease the blood cholesterol level. But among the conventional medicinal phosphorus adsorbents, there were some that adsorb not only phosphoric acid but also organic acids including raw materials of cholesterol such as bile acids (e.g., glycocholic acid), and consequently induce the hazard of a decrease in the blood cholesterol level. Therefore, there was a need to raise both the phosphoric acid adsorption capacity and the phosphoric acid selectivity.

Thereupon, an object of the present invention is to provide a phosphorus adsorbent comprising the crosslinked anion exchange resin that has excellent phosphorus adsorption capacity, by studying kinds of anion exchange resin and effects of crosslinking with crosslinking agents for the purpose of increasing the phosphorus adsorption capacity of anion exchange resin.

### DISCLOSURE OF THE INVENTION

A crosslinked anion exchange resin or a salt thereof of the present invention is characterized in that it is obtained by reacting a polymer (A) having amino and/or imino groups in the total number of two or more per a molecule with a compound (B) having a vinyl group which is capable of reacting in Michael addition reaction and a carboxylic ester group, and thus making the amino and/or imino groups contained in the polymer (A) add to the vinyl groups in the compound (B) by Michael addition reaction, and simultaneously making amino and/or imino groups contained in the polymer (A) form amide bonds with the carboxylic ester groups contained in the compound (B). It is because it was found that a crosslinking reaction of the polymer (A) through two or more amino or imino groups thereof with the compound (B) provided a crosslinked anion exchange resin excellent in the phosphorus adsorption capacity. This crosslinked anion exchange resin has an excellent phosphorus adsorbing capacity also in a salt form such as hydrochloride. Meanwhile, the “amino group or imino groups” in polymer (A) of the present invention include a nitrogen atom of tert-amine, and “polymers (A)” include polymers having the “amino or imino groups” above in the main chains and/or in the branched chains.

### BRIEF DESCRIPTION OF THE DRAWINGS

FIG. 1 is a bar graph showing the results of measurement of adsorption properties determined in EXPERIMENTAL EXAMPLE 9.

FIG. 2 is a bar graph showing the results of measurement of phosphorus and calcium excretion into urine determined in EXPERIMENTAL EXAMPLE 10.

FIG. 3 is a bar graph showing the results of phosphorus and calcium concentrations in blood determined in EXPERIMENTAL EXAMPLE 11.

FIG. 4 is a bar graph showing the results of protein excretion into urine determined in EXPERIMENTAL EXAMPLE 11.

### DESCRIPTION OF THE PREFERRED EMBODIMENTS

The crosslinked anion exchange resin or the salt thereof of the present invention is mainly characterized in that it is obtained by crosslinking a polymer (A) having amino and/or imino groups with a compound (B) having a vinyl group capable of reacting in Michael addition reaction and a carboxylic ester group.

The compound (B) is preferably reacted in an amount of 10 to 50 mol % with respect to the total moles of the amino and/or imino groups in the polymer (A). Even when the compound (B) is reacted in an amount of 50 mol %, at least the nitrogen atoms that have participated in the Michael addition reaction have activities and are capable of ion exchanging. The compound (B) is preferably a (meth)acrylic ester. It is because the crosslinking reaction can be conducted easily and reliably. Meanwhile, the term “(meth)acrylic” means acrylic and methacrylic.

The polymer (A) preferably has the number averaged molecular weight of 200 or more. In a favorable embodiment of the present invention, the polymer (A) is one or more polymer(s) selected from the group consisting of polyalkyleneimine, polyallylamine, polyvinylamine and allylamine-vinylamine copolymer. Amine value of the polymer (A) is preferably 8 to 67 mg eq/g.

The phosphorus adsorbent comprising crosslinked anion exchange resin and/or the salt thereof of the present invention may be used as a adsorbent for purification of water in lakes, lagoons and rivers as well as of wastewater and also as a phosphorus adsorbent for medicines. In particular, a medicine comprising the crosslinked anion exchange resin or a pharmaceutically acceptable salt thereof exerts a beneficial medicinal effect as a preventive and/or therapeutic agent of hyperphosphatemia.

The term, “polymer”, according to the present invention is not intended to mean only a homopolymer, but also include copolymers that do not impede the present inventive object and multi-component copolymers consisting of three or more components. Hereinafter, the present invention will be described in detail.

The crosslinked anion exchange resin or the salt thereof of the present invention can be obtained from polymer (A) having amino or imino groups in the total number of two or more in a molecule. Namely, the polymer (A) is not limited so far as the polymer has two or more amino groups, two or more imino groups, or one or more amino and imino groups respectively in a molecule. It is because the amino and/or imino groups are the sites being crosslinked with the compound (B). Since the crosslinking may become insufficient when there is only one crosslinking site in a polymer molecule, a polymer having amino and/or imino groups in the total number of two or more is preferably selected as the polymer (A). Even after the crosslinking reaction, the polymer still has amino or imino groups that are not involved in the crosslinking reaction and the amino and/or imino groups that have participated in the Michael addition reaction still have activities, and thus the polymer having the anion exchange capacity can be obtained.

Molecular weight of the polymer (A) above is not limited particularly, but preferably 200 or more as number averaged molecular weight. A polymer having the molecular weight below 200 is not favorable since the polymer provides a fragile crosslinked anion exchange resin with an inferior strength. The lower limit of the molecular weight thereof is more preferably is 500 or more as number averaged molecular weight. On the other hand, even though a polymer having a higher molecular weight is not particularly inconvenient, a polymer having an excessively high molecular weight may cause an entanglement of the polymer chains and thus affect the ion exchange property and the phosphorus adsorption property. Therefore, a polymer having the number averaged molecular weight of 10 million or less is recommended. The upper limit of the molecular weight is more preferably 1 million or less, more preferably 500 thousand or less, more preferably 200 thousand or less, and most preferably 100 thousand or less.

As described above, the polymer (A) above has amino and/or imino groups in the total number of two or more in a molecular, but the polymer (A) preferably has more amino and/or imino groups where the crosslinking reaction possibly occurs. Therefore, a polymer having alkyleneimine, vinylamine, or allylamine (including the salts thereof) as a main constitutional monomer, i.e., polyalkyleneimine, polyvinylamine, or polyallylamine is most preferable. Of course, polymers containing two or more polymers selected from alkyleneimine, vinylamine and allylamine may be also used, and a vinylamine-allylamine copolymer is most preferable. Additionally, modified resins (derivatives) prepared by reacting these amine polymers with ethylene oxide, glycidol or the like can also be used.

Meanwhile, as the polyalkyleneimine, polyethyleneimine and/or polyethylene-propyleneimine or the like can be preferably used, and alkyleneimine having an alkylene group of up to 8 carbons may also be used as a (co)monomer. Further, the polyethyleneimines are commercially available; for example, in a trade name “EPOMIN SP” series from Nippon Shokubai Co., Ltd. (e.g., “EPOMIN SP-006”, “EPOMIN SP-018”, “EPOMIN SP-200”, etc.), and these products may be used as the polymer (A).

Additionally, copolymers prepared by copolymerization of alkyleneimine, vinylamine, or allylamine mentioned above with other monomers may also be used as the polymer (A). “The other monomers” that may be copolymerized are, for example, monomers containing amino groups such as dimethylaminoethyl(meth)acrylate, diethylaminoethyl(meth)acrylate, dimethylaminopropyl(meth)acrylate, diethylaminopropyl(meth) acrylate, 2-hydroxydimethylaminopropyl(meth)acrylate, aminoethyl(meth)acrylate, etc, or the salts thereof such as hydrochloride, hydrobromide, sulfate, nitrate, acetate, propionate, etc.; monomers containing amide groups such as (meth)acrylamide, t-butyl(meth)acrylamide, etc.; monomers containing hydroxyl groups such as hydroxyethyl(meth)acrylate, polyethyleneglycol mono(meth)acrylate, polyethyleneglycol monoisoprenolether, polyethyleneglycol monoallylether, hydroxypropyl(meth)acrylate, polypropyleneglycol mono(meth)acrylate, polypropyleneglycol monoisoprenolether, polypropyleneglycol monoallylether, α-hydroxy acrylic acid, N-methylol(meth)acrylamide, vinylalcohol, allylalcohol, 3-methyl-3-buten-1-ol (isoprenol), glycerol monoallylether, etc.; (meth)acrylates such as methyl(meth)acrylate, ethyl(meth)acrylate, etc.; or styrene, α-methylstyrene, vinyl acetate, vinylpyrrolidone, vinyl ether, etc. Additionally, weak basic anion exchange resins known in the art containing amino or imino groups may also be used as the polymer (A).

A preferable range of the total amount of the amino and/or imino groups, defined by an amine value per gram of the polymer (A), is 8 to 67 mg eq/g. The polymer (A) having the amine value of smaller than 8 mg eq/g tends to yield a product insufficient in crosslinking. The more preferable lower limit of the amine value is 10 mg eq/g, and the upper limit is 25 mg eq/g. The amine value of the polymer (A) can be determined, for example, by neutralization titration in a nonaqueous solution. Concretely, the amine value can be determined by the following method.

(1) A solution of 0.5N p-toluenesulfonic acid in acetic acid (hereinafter, abbreviated as PTS) is prepared. About 0.3 g of sodium carbonate (purity: A mass %) is weighed (accurately to a 0.1 mg order) (sodium carbonate amount: M mg), and dissolved in 10 ml of methanol and 30 ml of acetic acid. The resulting solution is titrated with PTS, and a factor F of PTS is calculated from the titer (V₁ ml). The factor F of PTS is calculated by the following equation.

F=(M×A)/(100×105.99×2×V₁).

(2) About 0.2 g of polymer (A) (resin solid content: N mass %) is weighed (accurately to a 0.1 mg order) (amount: S g), and dissolved in 10 ml of methanol. After 30 ml of acetic acid was added to the solution, the resulting solution was titrated with PTS above and the amine value of polymer (A) is calculated from the titer (V₂ ml). The amine value (mg eq/g) per g of the polymer (solid content) is calculated by the following equation by using the factor F of PTS obtained in (1).

Amine value=(0.5×F×V₂)/(S×N×10).

In the present invention, the crosslinked anion exchange resin is obtained by reacting a polymer (A) having amino and/or imino groups with a compound (B) having a vinyl group capable of reacting in the Michael addition reaction and a carboxylic ester group used as a crosslinking agent. The vinyl group capable of reacting in the Michael addition reaction receives a nucleophilic attack of the amino and/or imino groups in the polymer (A), forming a bond between the polymer (A) and the compound (B) (Michael addition-type reaction). Additionally, the carboxylic ester group in this compound (B) reacts with the amino and/or imino group in the polymer (A), forming an amide bond. In each reaction, in case of that the amino and/or imino groups are present in different molecules of the polymer (A), the reaction yields a crosslinked polymer in which molecules of the polymer (A) are crosslinked with the compound (B).

As the Michael addition reactions proceed at ordinary temperature (25° C.), the polymer (A) and the compound (B) may be contacted and reacted at normal temperature to 60° C. The reaction period is properly selected according to the amount of the raw materials used. But the amide-bond forming reaction of the carboxylic ester does not proceed as easily as the Michael addition reaction, the reaction mixture is favorably further heated to 50 to 90° C. after the Michael addition reaction. The reaction period is not particularly limited, but usually about 1 to 100 hours. The reaction product is converted if desired to a salt by neutralizing with, for example, hydrochloric acid, and dried by the method known in the art to yield the anion exchange resin (salt form) of the present invention. The dried anion exchange resin may further be crushed according to the application thereof.

In the case where a polymer liquid at room temperature such as polyethyleneimine is used as the polymer (A), a solvent is not required for the reaction above, but if necessary, for example in the case where a polymer highly viscous or solid at ordinary temperature is used as the polymer (A), a solvent may be used for the crosslinking reaction described above. The solvent usable in such a case is preferably a solvent capable of dissolving the polymer (A) and the compound (B), and not participating in the crosslinking reaction, and the examples of the solvent include water, lower alcohols such as methanol, ethanol, isopropanol, etc., ethers such as tetrahydrofuran, 1,4-dioxane, isopropyl ether, etc., aromatic hydrocarbon solvents such as benzene, toluene, etc.

Concrete examples of the compound (B) are preferably (meth)acrylic esters, fumaric mono- or diesters, maleic mono- or diesters, itaconic mono- or diesters, etc. A proper selection of these compounds is favorable since it enables rapid progress of the Michael addition reaction and secures the amide-bond formation, thus leading to easy preparation of an anion exchange resin with a desired degree of crosslinking.

Favorable examples of the ester include, but not particularly limited to, alkylesters having 1 to 10 carbons, cycloalkylesters, benzylesters, etc., and more favorably, considering the succeeding processes necessary to remove the alcohol released by the amide-bond formation, alkylesters having 1 to 4 carbons, i.e., alkylesters having methyl to butyl groups. Especially favorable among the examples of the compound (B) above are (meth)acrylic alkylesters having these alkyl groups, and most favorable is methyl acrylate with the lowest molecular weight considering the phosphorus adsorption capacity per unit weight of the resulting phosphorus adsorbent.

The amount of the compound (B) to be used as a crosslinking agent is not limited but favorably in a range of 10 to 50 mol % with respect to total moles of the amino and imino groups. With the compound (B) used in an amount of less than 10 mol %, the resulting product does not have a sufficient degree of crosslinking nor occasionally provides a desired phosphorus adsorption capacity. When the compound (B) having two or more functional groups is added in an amount of 50 mol % in a reaction system, there still remain amino or imino groups left that are not involved in the crosslinking reaction, as are usually found in general chemical reactions. Further, amino or imino groups involved in the Michael addition reaction are still capable of ion exchanging by the presence of secondary and/or tertiary amines. Therefore, the preferable upper limit of the compound (B) to be added is set as 50 mol %. The upper limit of the compound (B) to be used is more preferably 40 mol % or less with respect to total moles of the amino or imino groups in the polymer (A), more preferably 30 mol % or less, and particularly preferably 25 mol % or less.

The crosslinked anion exchange resin of the present invention may be used as an anion exchange resin as they contain the amino or imino groups. Additionally, it may be converted to a salt thereof. Examples of the salt include salts of inorganic acids such as hydrochloric acid, sulfuric acid, bicarbonic acid, carbonic acid, nitric acid, phosphoric acid (not favorable when used as a phosphorus adsorbent), etc.; organic acids containing a carboxyl group such as oxalic acid, tartaric acid, benzoic acid, p-methoxybenzoic acid, p-hydroxybenzoic acid, valeric acid, citric acid, glyoxylic acid, glycolic acid, glyceric acid, glutaric acid, chloroacetic acid, chloropropionic acid, cinnamic acid, succinic acid, acetic acid, lactic acid, pyruvic acid, fumaric acid, propionic acid, 3-hydroxypropionic acid, malonic acid, butyric acid, isobutyric acid, amino acids, imidinoacetic acid, malic acid, isethionic acid, citraconic acid, adipic acid, itaconic acid, crotonic acid, salicylic acid, gluconic acid, glucuronic acid, gallic acid, sorbic acid, etc.; and organic acids containing a sulfonic acid group such as sulfoacetic acid, methanesulfonic acid, ethanesulfonic acid, etc. The crosslinked anion exchange resin may also be partially chelated.

Particularly when used for the medical application, the crosslinked anion exchange resin should be converted to a pharmaceutically acceptable salt, and thus salts including the salts of halides; inorganic acids salts such as hydrochloric acid, sulfuric acid, bicarbonic acid, carbonic acid, etc.; organic acids such as formic acid, acetic acid, propionic acid, malonic acid, succinic acid, fumalic acid, ascorbic acid, glucuronic acid, aspartic acid, amino acid salts such as glutamic acid, etc., organic acid salts such as sulfonic acid, etc., are recommended. Among them, a halide ion as the counter ion, in particular chloride ion, is favorable since the crosslinked anion exchange resin has the highest phosphate adsorption capacity when it has a chloride ion.

The crosslinked anion exchange resin or the salt thereof (hereinafter, referred to solely as the “crosslinked anion exchange resin”) of the present invention may be used in all areas where the weak basic anion exchange resins known in the art are now utilized. The crosslinked anion exchange resin of the present invention is extremely useful as a phosphorus adsorbent since it has an excellent phosphorus adsorption capacity.

The crosslinked anion exchange resin of the present invention has an excellent phosphate-ion adsorbing capacity, and thus may be used, in industrial applications, for removal of phosphate ions in water of lakes, lagoons, and rivers, or in wastewaters. In this case, the crosslinked anion exchange resin may be used as it is or attached on a support known in the art. Specific purification methods include, for example, a method by filling the crosslinked anion exchange resins in a treatment tank and subsequently introducing liquid to be treated thereto, and a method to sink a porous container such as a bag filled with the anion exchange resins in lakes, lagoons or the like to be treated. Additionally, the crosslinked anion exchange resins may be used in combination with other phosphorus adsorbents or other adsorbents, and in such a case, the combined adsorbent contains the crosslinked anion exchange resin of the present invention preferably in an amount of 0.1 mass % or more from a viewpoint of the phosphorus adsorption property. The phosphorus adsorbent of the present invention can be also used for the removal of phosphorus during food processing and applied for soil improvement.

The crosslinked anion exchange resin of the present invention is extremely useful as phosphorus adsorbent in medicinal application, particularly as a preventive and therapeutic agent of hyperphosphatemia for renal failure patients. Namely, when the medicine comprising the crosslinked anion exchange resin of the present invention is administered to a patient, though the anion exchange resin in the medicine are conveyed through gastrointestinal tract and finally excreted, it adsorbs phosphate ions contained in food ingested by the patient during the movement in the gastrointestinal tract, it suppresses the uptake and accumulation of phosphorus in patient, consequently leads to a decrease in phosphorus concentration in the blood of the patient. Additionally, the resin itself is unchanged during the aforementioned process except that the resin exerts the phosphorus adsorption action, and thus does not lead to adverse reactions of the conventional oral phosphorus adsorbents, such as aluminum preparation and the like. Furthermore, the crosslinked anion exchange resin of the present invention has a high adsorptivity to phosphate ions but a low adsorption capacity to organic acids derived from cholesterol such as glycocholic acid or the like contained in the bile acids secreted from the bile duct into the small intestine. Therefore, it also became clear that the crosslinked anion exchange resin does not have an inconvenience in that the cholesterol level in the blood is uselessly decreased by adsorbing glycocholic acid.

The crosslinked anion exchange resin of the present invention may be used as it is as a medicinal phosphorus adsorbent, in particular as an effective ingredient of a preventive and/or therapeutic agent of hyperphosphatemia, but is preferably blended with other common pharmaceutical additives into a formulation by the process well known in the art. The pharmaceutical formulations include tablets, capsules, granules, powders, pills, troches, liquids, etc., and are orally administered.

The medical compositions for oral administration can be formulated according to the process well known in the art, for example, by blending, filling, tabletting, etc. Additionally, the effective ingredient may be dispersed by repeated blending operations into a medicinal composition containing a large amount of fillers. For example, tablets or capsules for oral administration are preferably provided as a unit medicine, and thus may contain formulation support commonly used such as binders, fillers, diluents, tabletting agents, lubricants, disintegrants, coloring agents, flavoring agents and wetting agents, etc. The tablets may be, for example, coated with a coating agent into coat tablets according to the process well known in the art.

Preferable examples of the filler include cellulose, mannitol, lactose, etc., and disintegrants such as starch, polyvinylpyrrolidone, starch derivatives such as sodium starch glycolate, etc., or the like, and lubricants such as sodium laurylsulfate, etc., may be also used as the additives for the pharmaceutical formulations.

As a liquid formulation is provided a medical composition of aqueous or oil-based suspension, solution, emulsion, syrup, elixir, etc., or as dried medicines are provided medicinal compositions that can be redissolved before use in water or an adequate solvent. To the liquid formulation may be added the additives well known in the art, including precipitation inhibitors such as sorbitol, syrup, methylcellulose, gelatin, hydroxyethylcellulose, carboxymethylcellulose, aluminum stearate gel, hydrogenated edible fat, etc.; emulsifiers such as lecithin, sorbitan monooleate, gum acacia, etc.; oily esters such as almond oil, rectified coconut oil (including edible oil), glycerin esters, etc; nonaqueous solvents such as propionglycol (sic), ethyl alcohol, etc.; and preservation agents such as p-hydroxybenzoic methylester, sorbic acid, etc., as well as flavor agents or coloring agents or the like known in the art if desired.

In the formulation containing the medical composition for oral administration above, for example, in tablets, capsules, granules, powder, etc., the crosslinked anion exchange resin of the present invention is usually contained in an amount of 5 to 95 mass %, preferably in an amount of 25 to 90 mass %. The medical phosphorus adsorbent of the present invention is particularly useful for prevention and/or treatment of hyperphosphatemia derived from diseases associated with renal function disorders, and in particular for prevention and treatment of hyperphosphatemia accompanied with renal function disorders. The dosage of the preventive and/or therapeutic agent may be properly determined according to the age, health condition, weight, degree of disease, kind and frequency of the other therapies and treatments concomitantly proceeding, the nature of the desired effect, etc., of the patient. The dosage is generally 1 to 60 g as an effective ingredient per adult a day, and the medicine is recommended to be administered once or several times divided a day.

The preventive and/or therapeutic agent of hyperphosphatemia of the present invention decreases a phosphorus concentration in blood and an amount of phosphorus excretion into urine. Accordingly, it is anticipated that the preventive and/or therapeutic agent of the present invention is effective for prevention and/or treatment, not only of hyperphosphatemia, but of renal function disorders, chronic renal failure, dialysis, hypocalcemia, excessive secretion of parathyroid hormone (PTH), suppression of vitamin D activation, ectopic calcification, etc., which are thought to have hyperphosphatemia as the cause of disease.

Furthermore, it is also anticipated that the preventive and/or therapeutic agent of hyperphosphatemia of the present invention is effective for prevention and treatment of PTH increase caused by hyperphosphatemia, secondary hyperparathyroidism accompanied with a decline in vitamin D, renal bone dysplasia, uremia, central and periphery neuropathy, anemia, myocardial failure, hyperlipemia, glucose metabolism abnormality, itching disease, skin ischemic ulcer, anemia, tendon laceration, sexual dysfunction, muscular disorder, growth delay, cardiac conduction disturbance, pulmonary diffusion disturbance, arteriosclerosis, immune deficiency, etc.

### EXAMPLE

Hereinafter, the present invention will be described in more detail referring to EXAMPLES, but the following EXAMPLES are not intended to limit the present invention, and all modifications within a range of the scope of the present invention are embraced in the present invention. Meanwhile, crosslinked anion exchange resins were prepared according to the methods described below. Physical properties such as the number averaged molecular weight and the like were obtained referring to the product catalogue of Nippon Shokubai Co., Ltd. And calcium carbonate described in the Pharmacopoeia of Japan was used.

### Experimental Example 1

### (Preparative Example)

Into a 500 ml separable flask containing 100.0 g of polyethyleneimine (“EPOMIN SP-006”; number averaged molecular weight 600; amine value 20 mg eq/g-polymer; Nippon Shokubai Co., Ltd.) was added dropwise while stirring at 30° C. under a nitrogen atmosphere, 44.3 g of methyl acrylate (22.1 mol % with respect to the total moles of amino groups and/or imino groups in polyethyleneimine) over a period of 3 hours (mainly the Michael addition reaction proceeded). After the dropwise addition, the mixture was heated to 70° C. for 2 hours to promote the reaction (amide-bond forming reaction). After confirming the mixture being gelated (by progress of crosslinking), the mixture was cooled to 30° C. and cured at the same temperature for 15 hours. After curing, the mixture was separated from the separable flask and cured for additional 1 month at room temperature.

The crosslinked anion exchange resin thus obtained was crushed and poured into 664 ml of 3N aqueous hydrochloric acid solution and the resulting mixture was stirred for 24 hours. The crosslinked anion exchange resin hydrochloride obtained was collected by filtration. The filtered resin was repeatedly washed with water, and then poured into 10 L of water and the mixture was stirred for 24 hours. The filtered resin was collected by filtration and lyophilized to yield crosslinked anion exchange resin No.1.

### Experimental Example 2

### (Preparative Example 2)

According to the procedure described in EXPERIMENTAL EXAMPLE 1 except that 17.7 g of methyl acrylate (8.8 mol % with respect to the total moles of amino groups and/or imino groups in the following polyethyleneimine) was added dropwise into a 500 ml separable flask containing 100.0 g of polyethyleneimine same as that used in EXPERIMENTAL EXAMPLE 1, “EPOMIN SP-006”, the Michael addition reaction was conducted. After the dropwise addition of methyl acrylate, according to procedures described in EXPERIMENTAL EXAMPLE 1 except that the mixture was heated to and reacted at 70° C. for 2.5 hours, the amide-bond forming reaction and curing reactions were conducted. The crosslinked anion exchange resin thus obtained was crushed and poured into 778 ml of 3N aqueous hydrochloric acid solution and the resulting mixture was stirred for 24 hours. The crosslinked anion exchange resin hydrochloride obtained was collected by filtration. The filtered resin was washed repeatedly with water, and then poured into 10 L of water and the mixture was stirred for 24 hours. The filtered resin was collected by filtration and lyophilized to yield crosslinked anion exchange resin No.2.

### Experimental Example 3

### (Preparative Example 3)

Into a 500 ml separable flask containing 50.0 g of polyethyleneimine (“EPOMIN SP-018”; number averaged molecular weight 1800; amine value 19 mg eq/g-polymer; Nippon Shokubai Co., Ltd.) was added dropwise while stirring at 40° C. under a nitrogen atmosphere, 12.5 g of methyl acrylate (12.5 mol % with respect to the total moles of amino groups and/or imino groups in polyethyleneimine) over a period of 1.5 hours. After the dropwise addition, the mixture was heated to 70° C. and reacted for 2.5 hours. After confirming the mixture being gelated, the mixture was further cured at 70° C. for 72 hours. The crosslinked anion exchange resin thus obtained was crushed and poured into 373 ml of 3N aqueous hydrochloric acid solution and the resulting mixture was stirred for 24 hours. The crosslinked anion exchange resin hydrochloride obtained was collected by filtration. The filtered resin was repeatedly washed with water, and then poured into 10 L of water and the mixture was stirred for 24 hours. The filtered resin was collected by filtration and lyophilized to yield crosslinked anion exchange resin No.3.

### Experimental Example 4

### (Preparative Example 4)

According to the procedure described in EXPERIMENTAL EXAMPLE 3 except that 15.0 g of methyl acrylate (15.0 mol % with respect to the total moles of amino groups and/or imino groups in the following polyethyleneimine) was added dropwise into a 500 ml separable flask containing 50.0 g of polyethyleneimine, “EPOMIN SP-018”, crosslinked anion exchange resin No.4 was obtained.

### Experimental Example 5

### (Preparative Example 5)

According to the procedure described in EXPERIMENTAL EXAMPLE 3 except that 17.5 g of methyl acrylate (17.5 mol % with respect to the total moles of amino groups and/or imino groups in the following polyethyleneimine) was added dropwise into a 500 ml separable flask containing 50.0 g of polyethyleneimine, “EPOMIN SP-018”, crosslinked anion exchange resin No.5 was obtained.

### Experimental Example 6

### (Preparative Example 6)

Into a 500 ml separable flask containing 50.0 g of polyethyleneimine (“EPOMIN SP-200”; number averaged molecular weight 10,000; amine value 18 mg eq/g-polymer; Nippon Shokubai Co., Ltd.) was added dropwise while stirring at 50° C. under a nitrogen atmosphere, 10.0 g of methyl acrylate (10 mol % with respect to the total moles of amino groups and/or imino groups in polyethyleneimine) over a period of 1 hour. After the dropwise addition, the mixture was heated to 70° C. and reacted for 2.5 hours. After confirming the mixture being gelated, the mixture was cured at 70° C. for additional 72 hours. The crosslinked anion exchange resin thus obtained was crushed and poured into 405 ml of 3N aqueous hydrochloric acid solution and the resulting mixture was stirred for 24 hours. The crosslinked anion exchange resin hydrochloride obtained was collected by filtration. The filtered resin was washed repeatedly with water, and then poured into 10 L of water and the mixture was stirred for 24 hours. The filtered resin was collected by filtration and lyophilized to yield crosslinked anion exchange resin No.6.

### Experimental Example 7

### (Preparative Example 7)

Into a 500 ml separable flask containing 50.0 g of polyethyleneimine (“EPOMIN SP-200”) was added dropwise while stirring at 50° C. under a nitrogen atmosphere, 15.0 g of methyl acrylate (15 mol % with respect to the total moles of amino groups and/or imino groups in polyethyleneimine) over a period of 1.5 hours. After the dropwise addition, the mixture was heated to 70° C. and reacted for 2.5 hours. After confirming the mixture being gelated, the mixture was cured at 70° C. for additional 72 hours. The crosslinked anion exchange resin thus obtained was crushed and poured into 362 ml of 3N aqueous hydrochloric acid solution and the resulting mixture was stirred for 24 hours. The crosslinked anion exchange resin hydrochloride obtained was collected by filtration. The filtered resin was repeatedly washed with water, and then poured into 10 L of water and the mixture was stirred for 24 hours. The filtered resin was collected by filtration and lyophilized to yield crosslinked anion exchange resin No.7.

### Experimental Example 8

### (Preparative Example 8)

Into a 500 ml separable flask containing 50.0 g of polyethyleneimine (“EPOMIN SP-200”; number averaged molecular weight 10,000; amine value 18 mg eq/g-polymer; Nippon Shokubai Co., Ltd.) was added dropwise while stirring at 50° C. under a nitrogen atmosphere, 11.6 g of ethyl acrylate over a period of 0.5 hour. After the dropwise addition, the reaction was continued at 50° C. until the mixture was solidified. After confirming the mixture being solidified, the mixture was further heated to 60° C. and reacted for additional 1 hour. After the reaction was completed, the mixture was cured at room temperature for 72 hours. The product (5 g) thus obtained was poured into 100 ml of 0.36N aqueous hydrochloric acid solution, and the mixture was stirred for 24 hours. The solid was collected by filtration. The solid was washed in 400 ml of water, recollected by filtration, and lyophilized to yield crosslinked anion exchange resin No.8.

### Experimental Example 9

### (Measurement of Phosphate Ion Adsorption at Ion Concentration in Intestinal Solution)

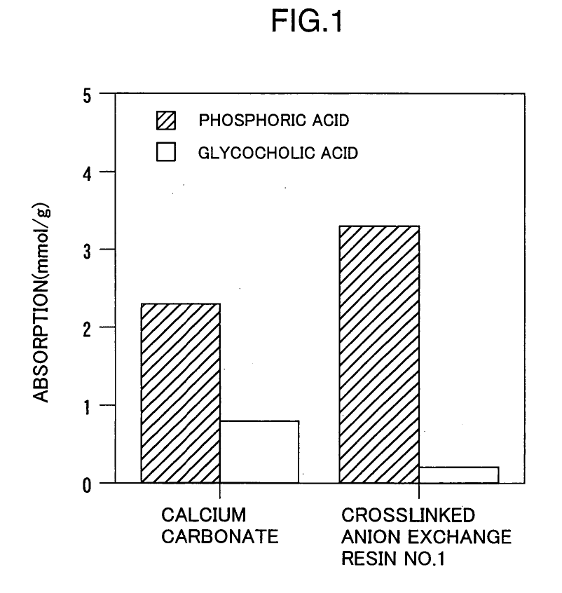

Phosphate ion and glycocholic acid adsorption properties of a crosslinked anion exchange resin and calcium carbonate were examined. In regard to an ion concentration in the intestinal solution, crosslinked anion exchange resin No.1 obtained EXPERIMENTAL EXAMPLE 1 and calcium carbonate were respectively added at a concentration of 1 mg/ml in solutions of 5 mM NaH₂PO₄ and 5 mM glycocholic acid, and the resulting mixtures were adjusted to pH 6:8 by the addition of sodium hydroxide and stirred at 37° C. for 1 hour. Subsequently, the resin was removed by ultrafiltration, and the amount of phosphoric acid that was not adsorbed on the resin was determined by the use of an inorganic phosphorus-measuring reagent (registered trademark “P-Test Wako”; Wako Pure Chemical Ind.). From the measured value, the amount of phosphoric acid adsorbed on the crosslinked anion exchange resin was calculated. And the amount of glycocholic acid which was not adsorbed on the resin was determined by the use of a bile acid measurement reagent (registered trademark “Total bile acid-Test Wako”; Wako Pure Chemical Ind.), and from the measured value, the amount of glycocholic acid adsorbed on the resin sample was calculated. The results were shown in FIG. 1.

It is apparent that crosslinked anion exchange resin No.1 has a larger phosphate adsorption capacity than calcium carbonate and an extremely low adsorption capacity of glycocholic acid. Meanwhile, with respect to crosslinked anion exchange resin No.2 obtained in EXPERIMENTAL EXAMPLE 2, a phosphate ion adsorption capacity determined was 0.77 mmol/g, smaller than that of the resin No.1.

### Experimental Example 10

### (Effects on Phosphorus Amount in Blood and Urine of Normal Rats)

Suppressive effects of crosslinked anion exchange resin No.1 obtained in EXPERIMENTAL EXAMPLE 1 and calcium carbonate to the increase in a phosphorus concentration in urine have been examined using Male SD rats (8 weeks old). First, feedstuff containing 0.3 mass % of phosphorus was fed for 7 days (20 g/rat/day). Subsequently, the feedstuff containing 0.58 mass % of phosphorus was blended with 0.6 g of crosslinked anion exchange resin No.1 obtained in EXPERIMENTAL EXAMPLE 1 or calcium carbonate, and the mixed feedstuff was administered over a period of 5 days (20 g/rat/day).

Before and 5 days after the first administration, urine for 24 hours was collected and the phosphorus amount in the urine was calculated from the concentration of phosphorus and the volume of the urine. The phosphorus and calcium concentration in urine was respectively determined by the use of an inorganic phosphorus-measurement reagent (registered trademark “P-test Wako”; Wako Pure Chemical Ind.) and calcium-measurement reagent (registered trademark “Calcium C-test Wako”; Wako Pure Chemical Ind.).

From the differences in the phosphorus amount before and 5 days after the first administration, urinary phosphorus excretions (increases in phosphorus excretion into urine [mg/24 hours]) were calculated and compared with those of the non-administered group. Meanwhile, 6 rats are used in each group.

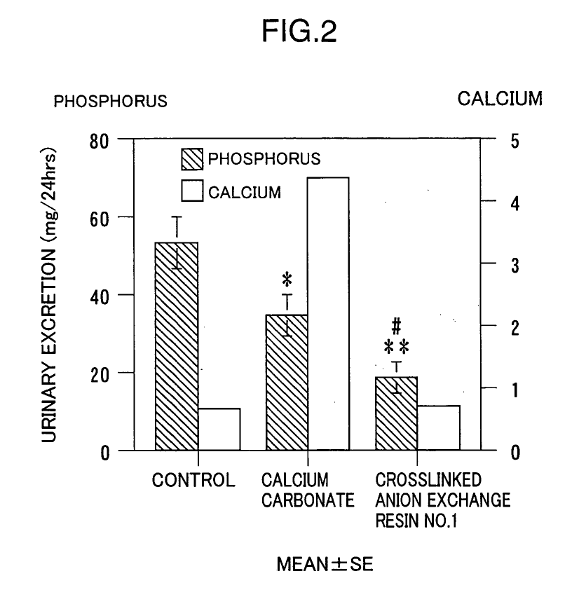

The results of the amount of phosphors or calcium excretion into urine are shown in FIG. 2. The amounts of phosphorus and calcium excretion respectively correspond to graduations in left and right vertical lines. It is found that the increase in the amount of phosphorus excretion into urine in the calcium carbonated administered group was suppressed with a statistically significant difference, compared to that of the control group, while the amount of calcium excretion was increased. In the group administered with the crosslinked anion exchange resin, the increase in the amount of phosphorus excretion into urine was found significantly suppressed and the effect to be far greater than that of the calcium carbonated administered group. Meanwhile in the FIGURE, * and ** indicate that the group has significant differences from the control (respectively, P<0.05 and P<0.01 in Student's T-Test). Additionally, # indicates that the group has a significant difference from the calcium carbonate-administered group (P<0.05 and P<0.01, Student's T-Test).

### Experimental Example 11

### (Effects on Phosphorus Concentration in Blood and Urine of 5/6 Nephrectomized Rats)

The effects of crosslinked anion exchange resin and calcium carbonate on the suppressive action on phosphorus amount in urine and on renal functions were examined using male SD rats (9 weeks old). First, 2/3 of the left kidneys of male SD rats and after a week, all of the right kidney thereof were removed to yield 5/6 nephrectomized rats. After 1 week, the administration of feedstuffs blended with calcium carbonate and crosslinked anion exchange resin No.1 obtained in EXPERIMENTAL EXAMPLE 1 respectively started. As the powdery feedstuff for rats was used MF manufactured by Oriental Yeast Co. Ltd., and the dosage was 15 g of the feedstuff containing 0.3 g of calcium carbonate or crosslinked anion exchange resin No.1, respectively. After 12 weeks from the day the 5/6 nephrectomized rats were obtained, blood samples were withdrawn from the tail veins of the rats, and the phosphorus and calcium concentration in blood was respectively determined by the use of an inorganic phosphorus-measurement reagent (above mentioned “P-test Wako”) and calcium-measurement reagent (above mentioned “Calcium C-test Wako”.). Additionally, before and after 12 weeks from the day the 5/6 nephrectomized rats were prepared, urines were collected-respectively for 24 hours, and protein concentrations in urine were determined by the use of a protein-measurement reagent (Protein Assay Kit, Bio-Rad). Meanwhile, the number of rats in each group used in the experiment was 9 respectively.

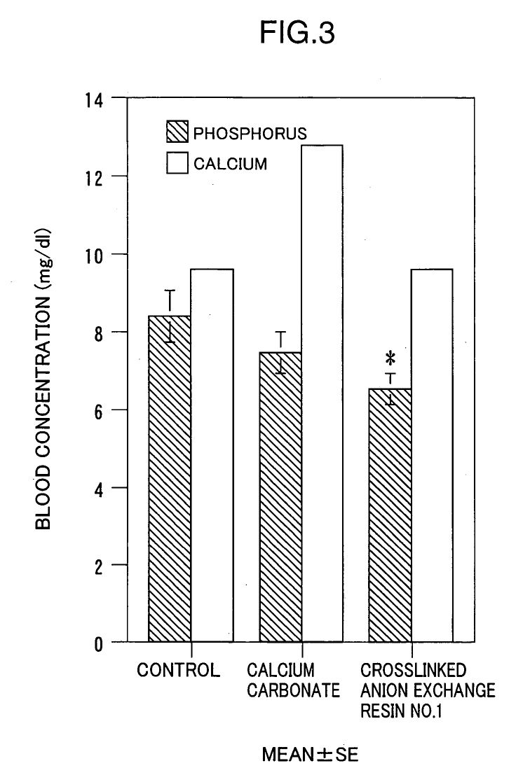

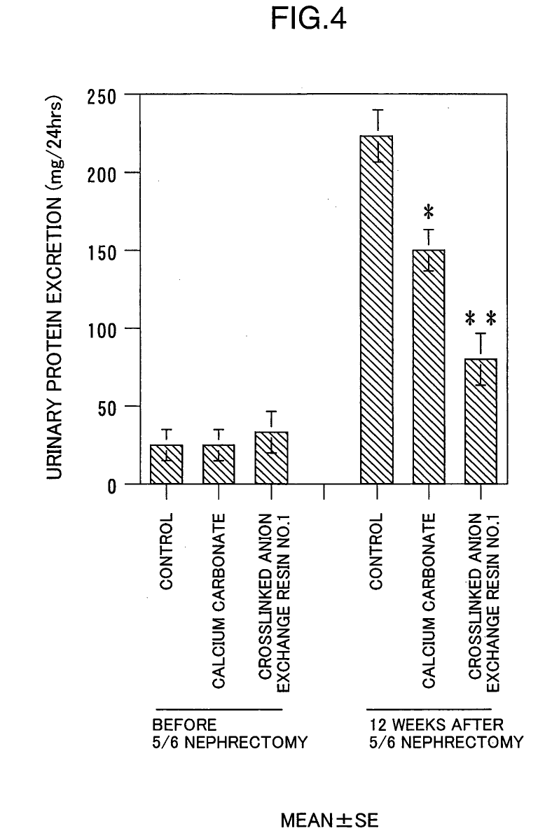

The results of the phosphorus and calcium concentrations in blood were shown in FIG. 3 and FIG. 4. As shown in FIG. 3, the calcium carbonate-administered group did not have a statistically significant difference in the blood phosphorus concentration, compared with the control, but had an increase in the blood calcium concentration. But in the group administered with crosslinked anion exchange resin No.1, a significant decrease in the phosphorus concentration was observed.

On the other hand as shown in FIG. 4, after 12 weeks from preparation of the 5/6 nephrectomized rats, a marked increase in protein excretion into urine was observed in the control, indicating the deterioration of renal function, while the increase in protein excretion into urine was significantly suppressed in the calcium carbonate administered group compared to the control. In the group administered with the crosslinked anion exchange resin, the increase in protein excretion into urine was also significantly suppressed, and the effect was greater than that of the calcium carbonated-administered group indicating an excellent suppressive effect thereof to the deterioration of renal function.

### INDUSTRIAL APPLICABILITY

A crosslinked anion exchange resin of the present invention is excellent in its phosphorus adsorption capacity and thus can be used as a phosphorus adsorbent for purification of lakes, lagoons and the like. Further, it adsorbs efficiently phosphorus in the gastrointestinal tracts, and thus could decrease the phosphorus concentration in blood and the phosphorus excretion into urine, consequently suppressing deterioration of renal functions. Therefore, the crosslinked anion exchange resin or the salt thereof of the present invention is also useful as a medicinal phosphorus adsorbent and as a preventive and therapeutic agent of hyperphosphatemia.

What is claimed is:

1. A crosslinked anion exchange resin or a salt thereof characterized in that it is obtained by reacting a polymer (A) having amino and/or imino groups in the total number two or more per molecule with a compound (B) having a vinyl group capable of reacting in Michael addition reaction and a carboxylic ester group, and thus by making the amino and/or imino groups contained in the polymer (A) add to the vinyl group in the compound (B) by Michael addition reaction and form a amide-bond with the carboxylic ester group in the compound (B).

2. A crosslinked anion exchange resin or a salt thereof according to claim 1, wherein said compound (B) is reacted in an amount of 10 to 50 mol % with respect to the total moles of the amino and/or imino groups in said polymer (A).

3. A crosslinked anion exchange resin or a salt thereof according to claim 1 or 2, wherein said compound (B) is a (meth)acrylic ester.

4. A crosslinked anion exchange resin or a salt thereof according to one of claims 1 to 3, wherein said polymer (A) has the number averaged molecular weight of 200 or more.

5. A crosslinked anion exchange resin or a salt thereof according to one of claims 1 to 4, wherein said polymer (A) is one or more polymer(s) selected from the group consisting of polyalkyleneimine, polyallylamine, polyvinylamine and allylamine-vinylamine copolymer.

6. A phosphorus adsorbent characterized by comprising a crosslinked anion exchange resin and/or a salt thereof according to one of claims 1 to 5.

7. A phosphorus adsorbent according to claim 6 for use as a medicine.

8. A preventive and/or therapeutic agent of hyperphosphatemia, characterized by comprising a crosslinked anion exchange resin or a pharmaceutically acceptable salt thereof according to one of claims 1 to 5.

9. (New) A crosslinked anion exchange resin or a salt thereof which is obtained by reacting a polymer (A) having amino and/or imino group in the total number two or more per molecule with a compound (B) having a vinly group capable of reacting in Michael addition reaction and a carboxylic ester group, and thus by making the amino and/or imino groups contained in the polymer (A) add to the vinyl group in the compound (B) by Michael addition reaction and form a amide-bond with the carboxylic ester group in the compound (B).

10. (New) The crosslinked anion exchange resin or salt thereof according to claim 9, wherein said compound (B) is reacted in an amount of 10 to 50 mol % with respect to the total moles of the amino and/or imino groups in said polymer (A).

11. (New) The crosslinked anion exchange resin or a salt thereof according to claims 9 or 10, wherein said compound (B) is a (meth)acrylic ester.

12. (New) The crosslinked anion exchange resin or a salt thereof according to claims 9 or 10, wherein said polymer (A) has a number averaged molecular weight of 200 or more.

13. (New) The crosslinked anion exchange resin or a salt thereof according to claim 11, wherein said polymer (A) has a number averaged molecular weight of 200 or more.

14. (New) The crosslinked anion exchange resin or a salt thereof according to claims 9 or 10, wherein said polymer (A) is one or more polymer(s) selected from the group consisting of polyalkyleneimine, polyallylamine, polyvinylamine and allylamine-vinylamine copolymer.

15. (New) The crosslinked anion exchange resin or a salt thereof according to claim 11, wherein said polymer (A) is one or more polymer(s) selected from the group consisting of polyalkyleneimine, polyallylamine, polyvinylamine and allylamine-vinylamine copolymer.

16. (New) The crosslinked anion exchange resin or a salt thereof according to claim 12, wherein said polymer (A) is one or more polymer(s) selected from the group consisting of polyalkyleneimine, polyallylamine, polyvinylamine and allylamine-vinylamine copolymer.

17. (New) The crosslinked anion exchange resin or a salt thereof according to claim 13, wherein said polymer (A) is one or more polymer(s) selected from the group consisting of polyalkyleneimine, polyallylamine, polyvinylamine and allylamine-vinylamine copolymer.

18. (New) A phosphorus adsorbent comprising a crosslinked anion exchange resin and/or a salt thereof according to claims 9 or 10.

19. (New) A phosphorus adsorbent comprising a crosslinked anion exchange resin and/or a salt thereof according to claim 11.

20. (New) A phosphorus adsorbent comprising a crosslinked anion exchange resin and/or a salt thereof according to claim 12.

21. (New) A phosphorus adsorbent comprising a crosslinked anion exchange resin and/or a salt thereof according to claim 13.

22. (New) A phosphorus adsorbent comprising a crosslinked anion exchange resin and/or a salt thereof according to claim 14.

23. (New) A phosphorus adsorbent comprising a crosslinked anion exchange resin and/or a salt thereof according to claim 15.

24. (New) A phosphorus adsorbent comprising a crosslinked anion exchange resin and/or a salt thereof according to claim 16.

25. (New) A phosphorus adsorbent comprising a crosslinked anion exchange resin and/or a salt thereof according to claim 17.

26. (New) A phosphorus adsorbent according to claim 18 for use as a medicine.

27. (New) A phosphorus adsorbent according to claim 19 for use as a medicine.

28. (New) A phosphorus adsorbent according to claim 20 for use as a medicine.

29. (New) A phosphorus adsorbent according to claim 21 for use as a medicine.

30. (New) A phosphorus adsorbent according to claim 22 for use as a medicine.

31. (New) A phosphorus adsorbent according to claim 23 for use as a medicine.

32. (New) A phosphorus adsorbent according to claim 24 for use as a medicine.

33. (New) A phosphorus adsorbent according to claim 25 for use as a medicine.

34. (New) A preventive and/or therapeutic agent of hyperphosphatemia, comprising a crosslinked anion exchange resin or a pharmaceutically acceptable salt thereof according to claims 9 or 10.

35. (New) A preventive and/or therapeutic agent of hyperphosphatemia, comprising a crosslinked anion exchange resin or a pharmaceutically acceptable salt thereof according to claim 11.

36. (New) A preventive and/or therapeutic agent of hyperphosphatemia, comprising a crosslinked anion exchange resin or a pharmaceutically acceptable salt thereof according to claim 12.

37. (New) A preventive and/or therapeutic agent of hyperphosphatemia, comprising a crosslinked anion exchange resin or a pharmaceutically acceptable salt thereof according to claim 13.

38. (New) A preventive and/or therapeutic agent of hyperphosphatemia, comprising a crosslinked anion exchange resin or a pharmaceutically acceptable salt thereof according to claim 14.

39. (New) A preventive and/or therapeutic agent of hyperphosphatemia, comprising a crosslinked anion exchange resin or a pharmaceutically acceptable salt thereof according to claim 15.

40. (New) A preventive and/or therapeutic agent of hyperphosphatemia, comprising a crosslinked anion exchange resin or a pharmaceutically acceptable salt thereof according to claim 16.

41. (New) A preventive and/or therapeutic agent of hyperphosphatemia, comprising a crosslinked anion exchange resin or a pharmaceutically acceptable salt thereof according to claim 17.
